(19) United States
(12) Patent Application Publication
(10) Pub. No.: US 2006/0050304 A1
(43) Pub. Date: Mar. 9, 2006

(54) Device management system

(75) Inventors: Takuya Abe, Nagano-ken (JP); Toshihiro Shima, Nagano-ken (JP); Atsushi Yoshino, Nagano-ken (JP); Akira Matsumoto, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/214,763

(22) Filed: Aug. 31, 2005

(30) Foreign Application Priority Data
Sep. 3, 2004 (JP) 2004-256638

(51) Int. Cl. G06F 3/12

(52) U.S. Cl. 358/1.15

(57) ABSTRACT

A management server has printer monitoring information that associates the time at which a network board begins printer monitoring and the printer being monitored. The management server receives from the network board the printer's serial number, the network board's MAC address and the time at which the network board was replaced, and registers these items of information in the printer monitoring information. The network board monitors the printer and collects log information. For each log file uploaded from the network board, the management server specifies and associates which printer the log file belongs to based on the time at which the log file was collected and printer monitoring information and stores the log file in the log database while maintaining such association.

### BACKGROUND OF THE INVENTION

1. Field of the Invention

The present invention relates to a device management system that manages devices over a network.

2. Description of the Related Art

In recent years, management systems that remotely manage printer through a network have become increasingly popular. In these types of management systems, a network board is installed in each printer. This network board has a configuration file in which are set monitored items that differ according to the model of the printer, and based on this configuration file, log information such as the remaining amounts or the amounts used of consumables such as ink and print job information are collected and uploaded to the device management apparatus. The device management apparatus has printer monitoring information that indicates which printer has a network board and is monitoring. Based on the monitoring information, the device management apparatus specifies which printer the uploaded log information is collected in, associates the printer and the log information, and stores the log information. When the network board is reinstalled in a different model of printer, the administrator manually updates the printer monitoring information.

However, in the conventional management method, it is extremely complex and costly when a network board has been replaced with a printer of different model printer, because the administrator has to update manually the log collection parameters. Furthermore, there is a risk that the administrator may forget to update the configuration file or may update the different configuration file.

These problems are not limited to management systems wherein a device management apparatus manages printers, but exist in various management systems in which a device management apparatus exchanges information with a device monitoring apparatus that monitors devices, while the device management apparatus manages the devices.

### SUMMARY OF THE INVENTION

In order to address at least one of the above problems, a first aspect of the present invention provides a device management apparatus that is connected with a device monitoring apparatus through a network, wherein the device monitoring apparatus monitors a device. The device management apparatus comprises a receiving module that receives use information and device identification information from the device monitoring apparatus, wherein the use information includes status of use of the device and the device identification information includes information for specifying the device that is targeted for monitoring, a use information storage module that stores the received use information and the received device identification information, an association module that associates the received use information and the received device identification information, and a management module that manages the device based on the use information.

Using the device management apparatus, the use information is able to be associated with a device even when the use information for multiple devices is included in the received use information from the device monitoring apparatus, and consistency of association with the device and the use information may be maintained. Furthermore, the administrative burden is able to be reduced by managing device use information using this device management apparatus.

A second aspect of the present invention provides the device monitoring apparatus that is connected with a device management apparatus through a network. The device monitoring apparatus comprises a use information obtaining module that obtains use information including status of use of the device based on monitored item configuration information, wherein the monitored item configuration information has an item for monitoring the device, a use information storage module that stores the obtained use information, a device identification information obtaining module that obtains device identification information for specifying the device that is targeted for monitoring, and a transmission module that transmits the use information and the device identification information to the device management apparatus.

According to the device monitoring apparatus of the present invention, the device monitoring apparatus is able to transmit the use information and the device identification information to the device management apparatus. Therefore, the device management apparatus is able to associate and manage use information and devices based on device identification information.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates a printer management system of a first embodiment;

FIG. 2 illustrates function blocks for the printer PRT1 of the first embodiment;

FIG. 3 illustrates the configuration file in the first embodiment;

FIG. 4 illustrates the contents of the log storage module in the first embodiment;

FIG. 5 illustrates function blocks of the management server SV of the first embodiment;

FIG. 6 illustrates printer monitoring information in the first embodiment;

FIG. 7 illustrates configuration file management information in the first embodiment;

FIG. 8 illustrates the contents of a log management table 341 in the first embodiment;

FIG. 9 is a flow chart showing the process by which the network board NB1 of the first embodiment monitors the printer PRT1;

FIG. 10 is a timing chart describing the process to obtain a configuration file in the first embodiment;

FIG. 11 is a flow chart showing the process to update the printer monitoring information 331 in the first embodiment;

FIG. 12 is a flow chart showing the log collection process in the first embodiment;

FIG. 13 is a flow chart showing the log storage process in the first embodiment;

FIG. 14 illustrates the contents of the log storage module of a second embodiment;

FIG. 15 illustrates function blocks for the management server SV of the second embodiment;

FIG. 16 is a flow chart showing the process by which the network board NB1 of the second embodiment monitors the printer PRT1;

FIG. 17 illustrates the log file upload process in the second embodiment;

FIG. 18 is a flow chart showing the log storage process in the second embodiment;

FIG. 19 illustrates the function blocks of the printer PRT1 of a third embodiment;

FIG. 20 illustrates the contents of the printer monitoring information of the third embodiment; and

FIG. 21 is a flow chart showing the log storage process in the third embodiment.

### DESCRIPTION OF THE PREFERRED EMBODIMENT

Embodiments of the present invention will be described below based on embodiments.

A1. System Structure

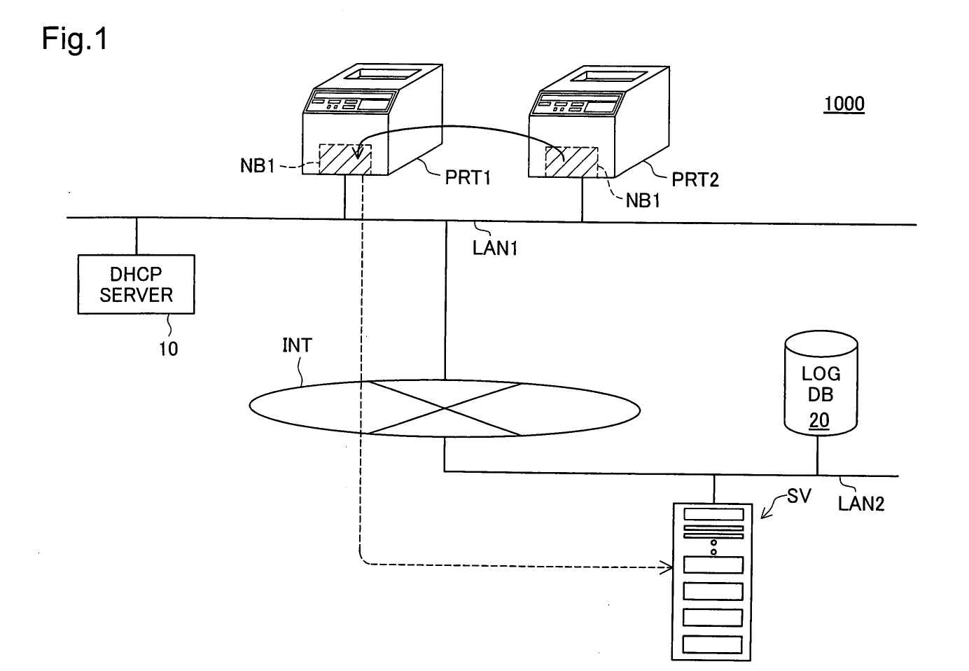

FIG. 1 illustrates the schematic structure of a printer management system 1000 of an embodiment of the invention. The printer management system 1000 has a management server SV, a log database 20 (hereinafter termed the ‘a log DB 20’), printers PRT1, PRT2, and a DHCP (Dynamic Host Configuration Protocol) server 10. The printers PRT1, PRT2 and the DHCP server 10 are connected to a local area network LAN1. The management server SV and the log DB 20 are connected to a local area network LAN2. The local area networks LAN 1 and LAN 2 are connected over the Internet INT. When power supply of the printers PRT1, PRT2 connected to the local area network LAN1 is turned ON, IP addresses are allocated thereto by the DHCP server 10. The management server SV corresponds to the ‘device management apparatus’ in this invention, while the printers PRT1, PRT2 correspond to the ‘device’ therein.

The printer PRT2 has a network board NB1 that serves as a network interface. The network board NB1 monitors and collects logs of the status of use of the printer PRT2 based on a configuration file not shown. The items monitored include, for example, the remaining amounts of consumables such as ink. The network board NB1 stores log files having the collected log information and uploads log files to the management server SV as appropriate. Different items are included in the configuration file for each printer serial number. In this embodiment, the network board NB1 that was installed in the printer PRT2 may be reinstalled in the printer PRT1 as shown by the solid arrow in FIG. 1.

The network board NB1 checks the serial number of the printer PRT1 in which the network board NB1 is installed and the serial number of the printer PRT2 recorded on the network board NB1. When the two serial numbers are not identical, the network board NB1 notifies the management server SV of the serial number of the printer PRT1, the MAC address of the network board NB1 and update time at which the network board NB1 determined that the serial numbers of the printer PRT1 and the printer PRT2 differ, as indicated by the broken arrow in FIG. 1.

The management server SV has printer monitoring information in which the time that the network board NB1 began printer monitoring and the printer monitored by the network board NB1 are associated. The management server SV receives the serial number of the printer PRT1, the MAC address of the network board NB1 and the update time from the network board NB1, and records the serial number of the printer PRT1, the MAC address of the network board NB1 and the update time in the printer monitoring information. After the recording, the management server SV transmits the configuration file corresponding to the serial number of the printer PRT1 to the network board NB1. The configuration file includes the items for monitoring the printer PRT1 by the network board NB1.

The network board NB1 monitors the printer PRT1 based on the received configuration file and collects log information regarding the remaining ink amount and other information pertaining to the printer PRT1. The network board NB1 periodically uploads the collected log information to the management server SV.

The management server SV associates the uploaded log file with the printer corresponding to the log file based on the log collected time and the printer monitoring information.

A2. Function Blocks

A2-1. Printer Function Block

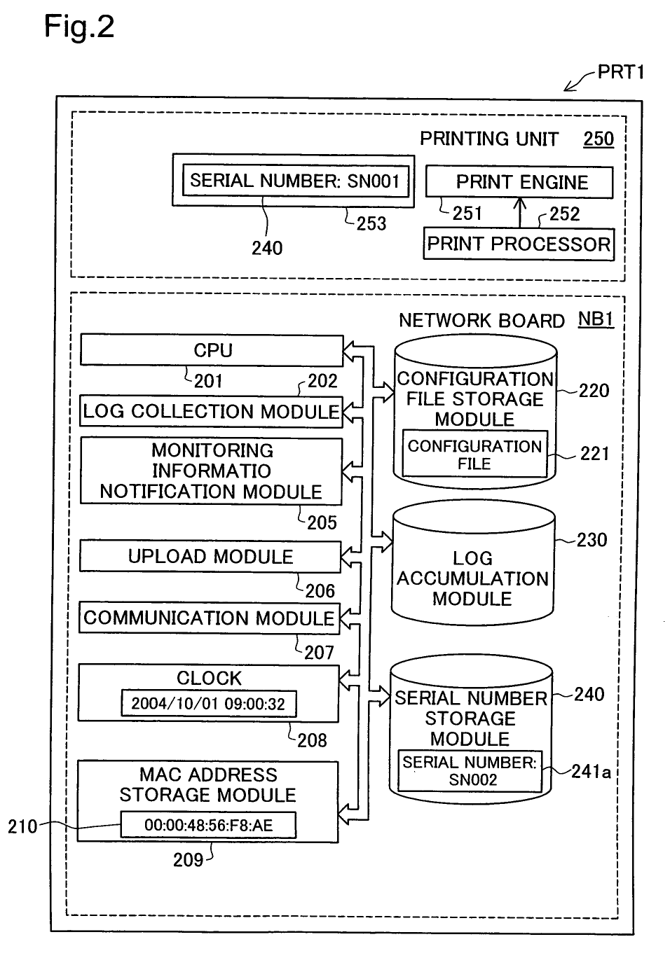

FIG. 2 is a function block for the printer PRT1 in this embodiment. The printer PRT1 includes a printing unit 250 and the network board NB1. The printer PRT2 has the identical structure. The printing unit 250 includes a print engine 251, a print processor 252 and a non-volatile memory 253.

The print processor 252 enable a print job received via the network board NB1 enable to be printed and transfers the print job to the print engine 251. The print engine 251 prints the transferred print job. The serial number 241 of the printer PRT1 is recorded in the non-volatile memory 253. As shown in FIG. 2, the serial number 241 of the printer PRT1 is ‘SN001’.

The network board NB1 includes a CPU 201, a log collection module 202, a monitoring information notification module 205, an upload module 206, a communication module 207, a clock 208, a MAC address storage module 209, a configuration file storage module 220, a log storage module 230 and a serial number storage module 240. The log collection module 202, monitoring information notification module 205, upload module 206 and communication module 207 are implemented via software controlled by the CPU 201. Each of these function blocks may alternatively be implemented via hardware, however. A Memories installed on the network board NB1 has the configuration file storage module 220, log storage module 230 and serial number storage module 240. The MAC address storage module 209 is recorded in a non-volatile memory installed on the network board NB1.

The clock 208 is a real-time clock that maintains the current time even if the power supply of the printer PRT1 is turned OFF.

The serial number of the printer to be monitored by the network board NB1 is stored in the serial number storage module 240. FIG. 2 illustrates the situation immediately after the network board NB1 is replaced from the printer PRT2 to the printer PRT1. Thus the serial number storage module 240 is still storing the serial number 241a of the printer PRT2.

The monitoring information notification module 205 determines whether the serial number 241 of the printer PRT1 recorded in the non-volatile memory 253 (hereinafter termed the ‘current serial number 241’) is identical to the serial number 241a recorded in the serial number storage module 240. When monitoring information notification module 205 determines that the serial numbers are not identical, the monitoring information notification module 205 determines that the network board NB1 has been reinstalled, and obtains the MAC address 210 of the network board NB1 with reference to the MAC address storage module 209 and the current time at that moment (the ‘update time’) with reference to the clock 208. Next, the monitoring information notification module 205 then transmits the current serial number 241, network board NB1 MAC address and update time to the management server SV.

Together with transmitting the current serial number 241, MAC address 210 and update time, the monitoring information notification module 205 transmits a request to obtain the configuration file corresponding to the printer PRT1. The monitoring information notification module 205 receives the configuration file 221 in response to this request and stores the configuration file 221 in the configuration file storage module 220. The monitoring information notification module 205 includes the functions of the ‘device identification information obtaining module’ and the monitoring information transmission module’ of the present invention.

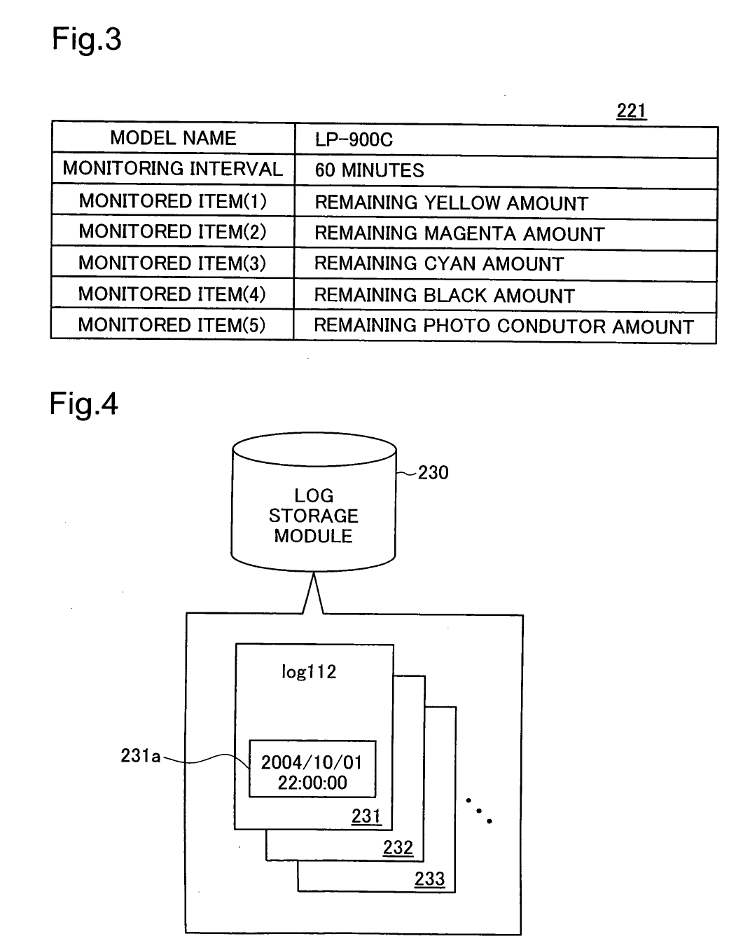

The log collection module 202 determines with reference to the clock 208 whether it is time to collect log information. When it is time to collect log information, the log collection module 202 collects log information regarding the status of use of the printer PRT1 based on the monitored items included in the configuration file 221, generates a log file, and stores the log file in the log storage module 230. The time of collection of the log information is included in the log file. The log collection module 202 corresponds to the ‘use information obtaining module’ of the present invention. The details of the configuration file 221 are described with reference to FIG. 3, while the contents of the log storage module 230 are described with reference to FIG. 4.

FIG. 3 illustrates the configuration file in this embodiment. Monitored items when the printer PRT1 is monitored are set in the configuration file 221, which is stored in the configuration file storage module 220. The configuration file 221 comprises the model name, the monitoring interval, and monitored items (1)-(5). The printer PRT1 is a color printer and includes the four ink colors of yellow, magenta, cyan and black as well as a single photo conductor.

The ‘Model name’ indicates the model name ‘LP-900C’ of the printer PRT1. The ‘Monitoring interval’ is set at ‘60 minutes’, indicating that the log collection module 202 collects log information regarding the items set in the monitored items (1)-(5) every 60 minutes after monitoring is begun, with reference to the clock 208. ‘Remaining yellow amount’ is set in the monitored item (1), indicating that the remaining amount of yellow ink is to be monitored. Similarly, the monitored item (2) indicates the monitoring of the remaining amount of magenta ink, the monitored item (3) indicates the monitoring of the remaining amount of cyan ink, and the monitored item (4) indicates the monitoring of the-remaining amount of black ink. Set in the monitored item (5) is ‘Remaining photo conductor amount’, indicating that the remaining amount of the photo conductor of the printer PRT1 is to be monitored.

FIG. 4 illustrates the contents of the log storage module 230 of the network board NB1 in this embodiment. The log storage module 230 stores log files 231, 232, 233 . . . collected by the network board NB1. The log files are described below using the log file 231 as an example. As shown in FIG. 4, the file name of the log file 231 is ‘log112’. The collection time 231a at which log information was collected is included in the log file 231. Information having the status of use collected based on the monitored items included in the configuration file 221 is recorded in the log file 231. The printer to which the log pertains is not able to be specified solely from the log file 231. Other log files are generated in the same form.

Returning to FIG. 2, the communication module 207 is a so-called network interface, and communicates with the management server SV and other apparatuses.

The upload module 206 uploads the log files stored in the log storage module 230 to the management server SV when it is time to upload log files.

A2-2. Management Server Function Block

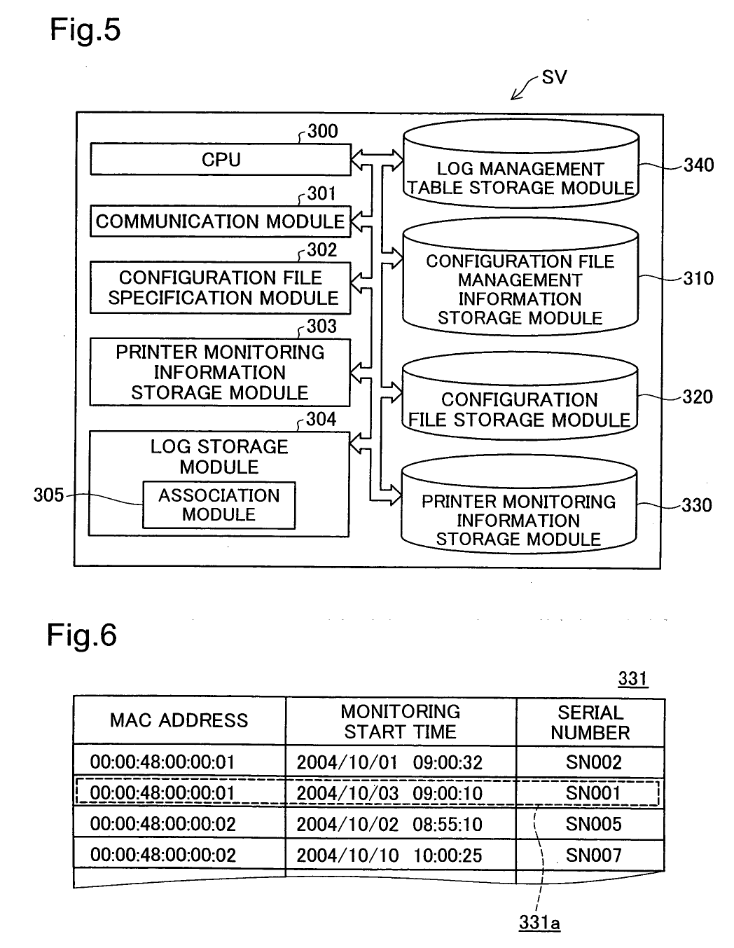

FIG. 5 illustrates a function block of the management server SV in this embodiment. The management server SV includes a CPU 300, a communication module 301, a configuration file specification module 302, a printer monitoring information management module 303, a log storage module 304, an association module 305, a configuration file management information storage module 310, a configuration file storage module 320, a printer monitoring information storage module 330 and a log management table storage module 340. Each of these function blocks is implemented via software and is controlled by the CPU 300. Each function block may alternatively be implemented via hardware, however.

The communication module 301 is a so-called network interface, and enables communication with the network board NB1 or log DB 20 and other components.

When the current serial number 241, MAC address 210 and update time are obtained from the network board NB1, the printer monitoring information management module 303 registers the current serial number 241, MAC address 210 and update time in the printer monitoring information stored in the printer monitoring information storage module 330. The printer monitoring information management module 303 and the printer monitoring information storage module 330 include functions corresponding to those of the ‘device identification information storage module’ of the management device of the present invention. The printer monitoring information will now be described with reference to FIG. 6.

FIG. 6 illustrates printer monitoring information in this embodiment. The printer monitoring information 331 has the items of ‘MAC address’, ‘Monitoring start time’ and ‘Serial number’. ‘MAC address’ indicates the MAC address of the network board. ‘Monitoring start time’ indicates the update time notified from the network board. ‘Serial number’ indicates the serial number notified from the network board, i.e., the serial number of the printer to be monitored by the network board. The information shown in the row enclosed by a dashed line in FIG. 6 is information notified from the network board NB1 and registered by the printer monitoring information management module 303.

For example, printer monitoring information 331 shows that the network board NB1 having a MAC address of ‘00:00:40:00:00:01’ monitors the printer PRT2 having the serial number of ‘SN002’ from ‘2004/10/01 09:00:32’, and monitors the printer PRT1 having the serial number of ‘SN001’ from ‘2004/10/03 09:00:10’. In other words, the network board NB1 monitors the printer PRT2 during the period from ‘2004/10/01 09:00:32’ to ‘2004/10/03 09:00:09’, and starts to monitor the printer PRT1 from at ‘2004/10/03 09:00:10’.

Returning to FIG. 5, the printer monitoring information management module 303 instructs the configuration file specification module 302 to specify the configuration file corresponding to the serial number notified from the network board NB1 and to transmit the file to the network board NB1.

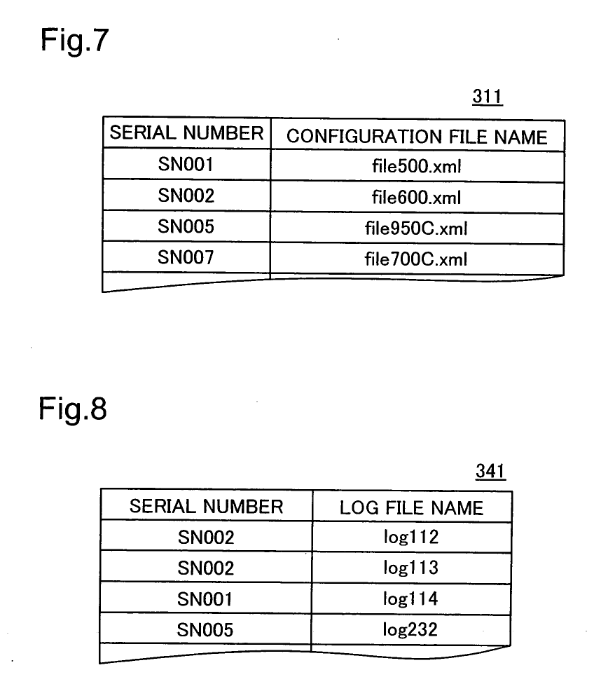

Multiple configuration files are stored in the configuration file storage module 320 for each printer serial number. Configuration file management information is stored in the configuration file management information storage module 310. The configuration file management information 311 is information that associates the configuration file for monitoring a printer by network board with the printer's serial number. The configuration file management information 311 will be described in detail below with reference to FIG. 7.

FIG. 7 illustrates configuration file management information in this embodiment. The configuration file management information 311 has the two items of ‘Serial number’ and ‘Configuration file name’. For example, configuration file management information 311 indicates that the printer having the serial number of ‘SN001’ is monitored based on the monitored items set in the configuration file having the file name ‘file500.xml’.

Returning to FIG. 5, when a configuration file transmission instruction is received from the printer monitoring information management module 303, the configuration file specification module 302 specifies the configuration file name corresponding to the current serial number notified from the network board NB1 with reference to the configuration file management information storage module 310 and transmits the specified configuration file to the network board NB1. In this embodiment, the configuration file specification module 302 specifies the configuration file named ‘file500.xml’, the configuration file named ‘file500.xml’ corresponds to the serial number ‘SN001’ of the printer PRT1, and transmits to the network board NB1.

A log management table 341 is stored in the log management table storage module 340.The log management table 341 is described in detail below with reference to FIG. 8.

FIG. 8 illustrates a log management table 341 in this embodiment. The log management table 341 has the two items of ‘Serial number’ and ‘Log file name’ as shown in FIG. 8. For example, log management table 341 indicates that the log file names ‘log112’ and ‘log113’ are log files corresponding to the serial number ‘SN002’, i.e., the printer PRT2. Similarly, a log management table 341 indicates that the log file name ‘log114’ is a log file corresponding to the serial number ‘SN001’, i.e., the printer PRT1.

The association module 305 is a part of the log storage module 304. The association module 305 records associations between log files and printers based on (i) the collection times of the log files uploaded from the network board NB1 and (ii) the printer monitoring information storage module 330. The association module 305 corresponds to the ‘association module’ of the present invention.

The log storage module 304 stores log files in the log DB 20. In this embodiment, the log DB 20 is separated from the management server SV, but the log DB 20 may be integrated therewith. In addition, in this embodiment, the log DB 20 and the management server SV are connected through a network, but the log DB 20 may be connected locally to the management server SV via a SCSI interface or other interface installed therein. The log DB 20 and the log storage module 304 include functions corresponding to the ‘use information storage module’ of the management apparatus of present invention.

A3. Printer Monitoring Process

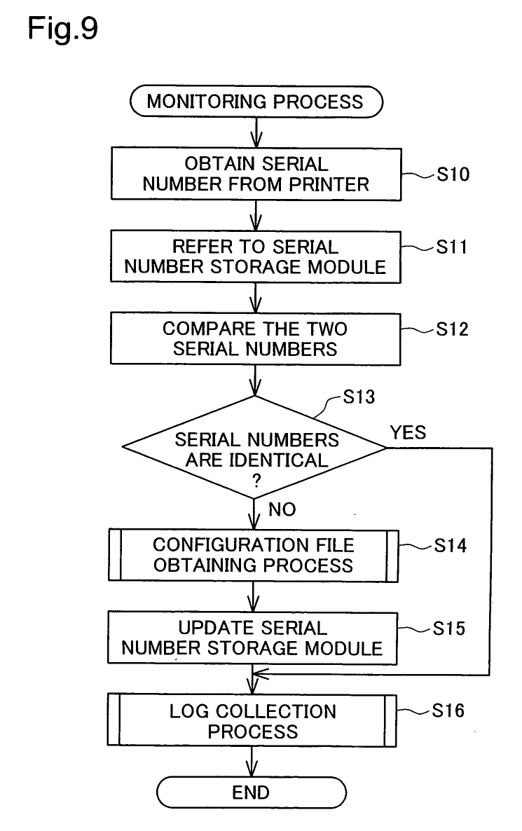

FIG. 9 is a flow chart describing the process by which the network board NB1 monitors the printer PRT1 in this embodiment. The network board NB1 begins this process when the power supply of the printer PRT1 is turned ON.

The network board NB1 obtains the current serial number 241 from the printing unit 250 (step S10). The network board NB1 then obtains the serial number 241a with reference to the serial number storage module 240 (step S11).

The network board NB1 compares the current serial number 241 and the serial number 241a (step S12) and determines whether or not the two serial numbers are identical (step S13). If the two serial numbers are identical (YES in step S13), the network board NB1 begins monitoring the printer PRT1 and collects the log information (step S16). By determining whether or not the two serial numbers are identical when power supply of the printer is turned ON, the processing burden is able to be reduced without having to repeat the operation of obtaining a configuration file.

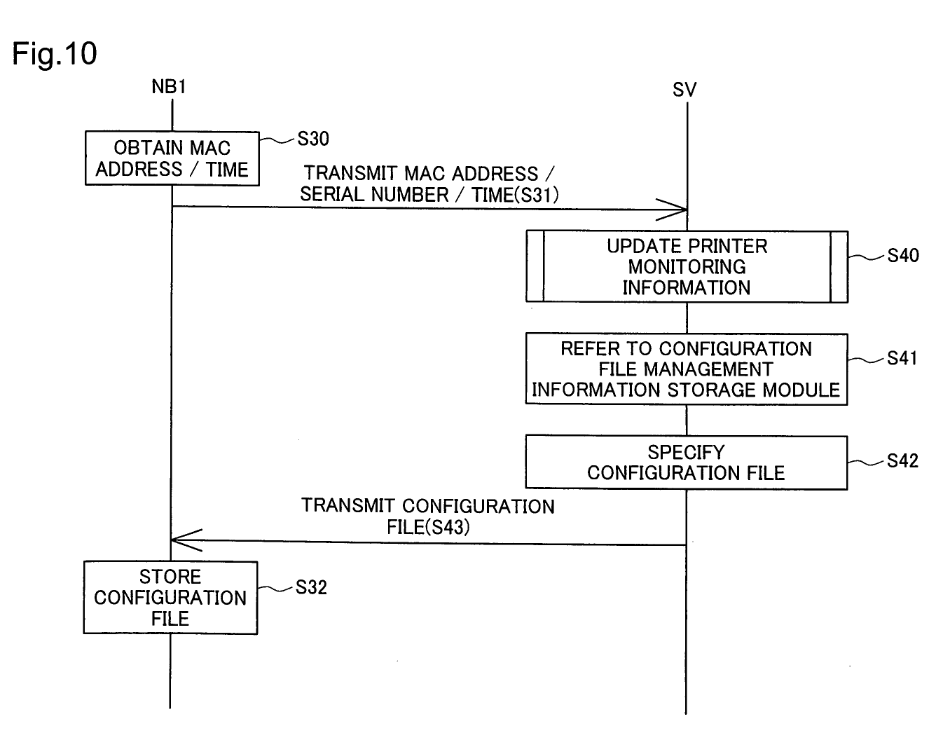

If the two serial numbers are not identical (NO in step S13), the network board NB1 obtains the configuration file corresponding to the printer PRT1 (step S14). The operation to obtain the configuration file is described in detail below with reference to FIG. 10.

FIG. 10 is a timing chart describing the process to obtain a configuration file in this embodiment. The network board NB1 obtains the MAC address of the network board NB1 and the update time (step S30), and transmits the current serial number 241, the MAC address 210 and the update time to the management server SV (step S31).

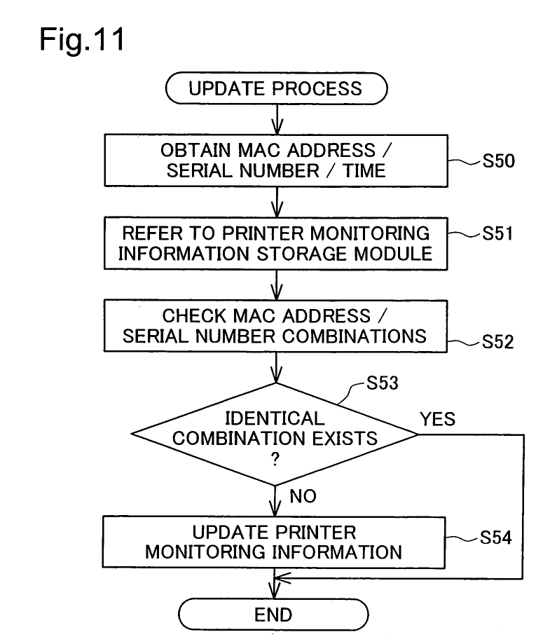

When the management server SV receives the current serial number 241, MAC address 210 and update time, the management server SV updates the printer monitoring information 331 (step S40). The operation to update the printer monitoring information 331 is described in detail below with reference to FIG. 11.

FIG. 11 is a flow chart showing the process to update the printer monitoring information 331 in this embodiment. When the management server SV receives the current serial number 241, MAC address 210 and update time from the network board NB1 (step S50), the management server SV refers to the printer monitoring information storage module 330 (step S51) and determines whether or not a combination of the received MAC address 210 and the current serial number 241 exists (step S52). If a combination identical to the combination of the MAC address 210 and the current serial number 241 exists (YES in step S53), the management server SV ends the process. If a combination identical to the combination of the MAC address 210 and the current serial number 241 does not exist (NO in step S53), the management server SV registers the received MAC address 210, current serial number 241 and update time in the printer monitoring information 331 and updates the printer monitoring information 331 (step S54).

Returning to FIG. 10, the management server SV refers to the configuration file management information storage module 310 (step S41) and specifies the configuration file corresponding to the received current serial number 241 (step S42). The management server SV transmits the specified configuration file to the network board NB1 (step S43).

The network board NB1 receives the configuration file transmitted from the management server SV and stores the configuration file in the configuration file storage module 220 (step S32).

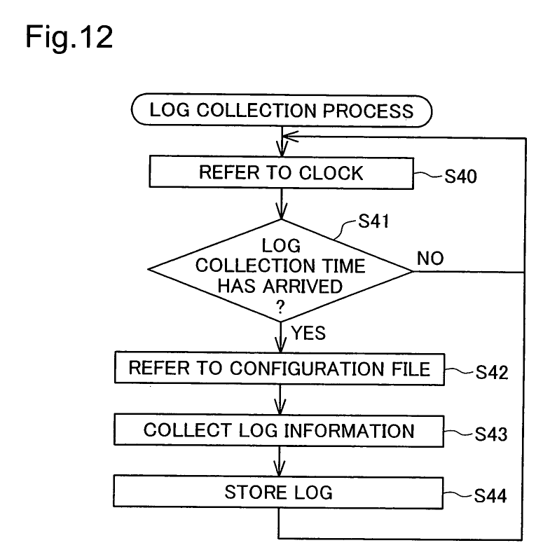

Returning to FIG. 9, the network board NB1 stores the serial number 241 of the printer PRT1 in the serial number storage module 240 after the configuration file is obtained. In other words, the network board NB1 updates the serial number storage module 240 by rewriting the serial number 241a stored in the serial number storage module 240 (‘SN002’) with the current serial number 241 (‘SN001’) (step S15). The network board NB1 then begins monitoring and carries out the log collection process (step S16). The log collection process is described in detail below with reference to FIG. 12.

FIG. 12 is a flow chart showing the log collection process of this embodiment. When the network board NB1 begins monitoring, the network board NB1 checks the clock 208 (step S40) and determines whether or not the time for log collection has arrived (step S41). If the log collection time has arrived (YES in step S41), the network board NB1 refers to the configuration file 221 (step S42) and collects log information for the printer PRT1 such as the log information regarding the remaining ink amounts (step S43). It then stores the collected logs in the log storage module 230 (step S44). If the log collection time has not arrived (NO in step S41), the network board NB1 returns to step S40 and repeats the process.

A4. Log Storage Process

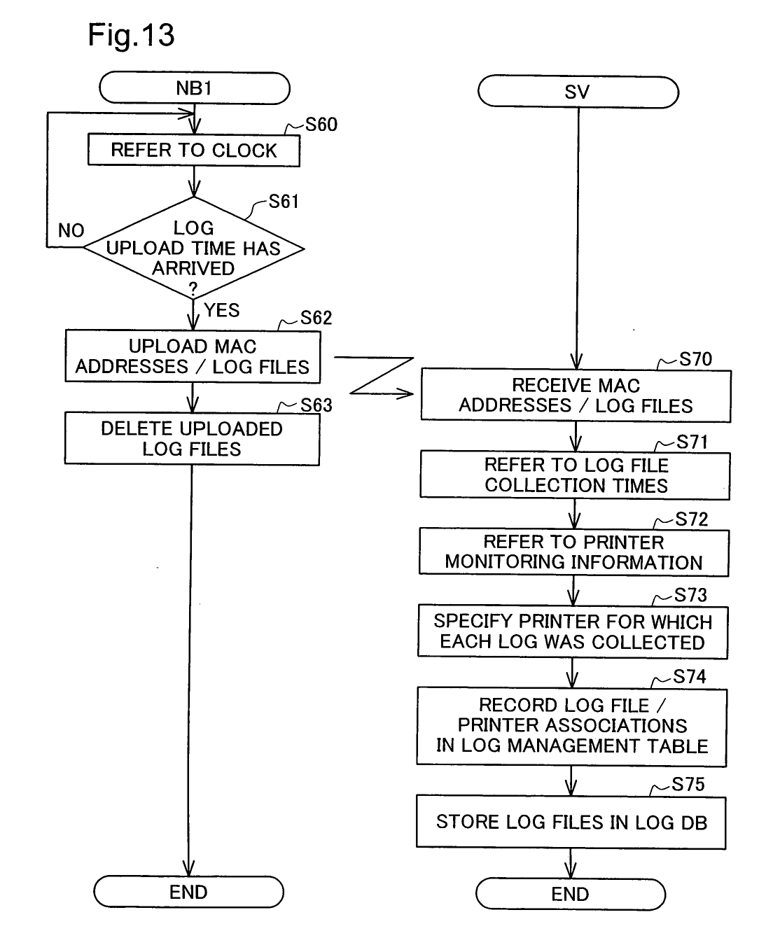

FIG. 13 is a flow chart showing the log storage process in this embodiment. This is a process in which the network board NB1 regularly uploads the collected log files to the management server SV and the management server SV stores the uploaded log files in the log DB 20.

The network board NB1 refers to the clock 208 (step S60) and determines whether or not the time for uploading log files to the management server SV has arrived (step S61). If the upload time has not arrived yet (NO in step S61), the network board NB1 returns to step S60 and repeats the process. If the upload time has arrived (YES in step S61), the network board NB1 obtains the log files stored in the log storage module 230 and the MAC address of the network board NB1 and uploads the log files and the MAC address (step S62). The network board NB1 then deletes the uploaded log files (step S63).

When the management server SV receives the log files uploaded from the network board NB1 and the MAC address 210 of the network board NB1 (step S70), the management server SV refers to the log file collection times 231a (step S71). The management server SV then refers to the printer monitoring information 331 (step S72) and specifies the serial number for the printer associated with each log file (step S73).

The management server SV then associates and records the specified serial numbers and log files in the log management table 341 (step S74) and stores the log files in the log DB 20 (step S75).

According to the printer management system 1000 of the first embodiment described above, the management server SV is able to keep track of the most current printer/network board combinations through the use of a printer management table. Furthermore, because the management server SV keeps track of the times during which the network board was monitoring each printer based on the printer management table, the management server SV is able to easily associate a log file with a printer based on (i) the time in the log file that was uploaded by the network board and (ii) the printer management table. Therefore, even while log files for multiple printers are included in the log files uploaded from the network board NB1, the management server SV is able to associate each log file with printer and is able to ensure consistency in determining which log files were collected for which printers. Furthermore, the management server SV is able to efficiently keep track of the state of use and state of failure of the printers based on log files. In addition, the administrator is able to reduce the administrative burden by managing printer log files using the above management server SV.

B. Second Embodiment

In a second embodiment, after the network board NB1 is replaced from the printer PRT2 to the printer PRT1, the serial number of the printer PRT1 is stored in the log storage module 230 as a log file, and uploading to the management server SV is carried out in ascending order of the collection times of the log files accumulated in the log storage module 230.

B1. Function Blocks:

B1-1 Log Storage Module:

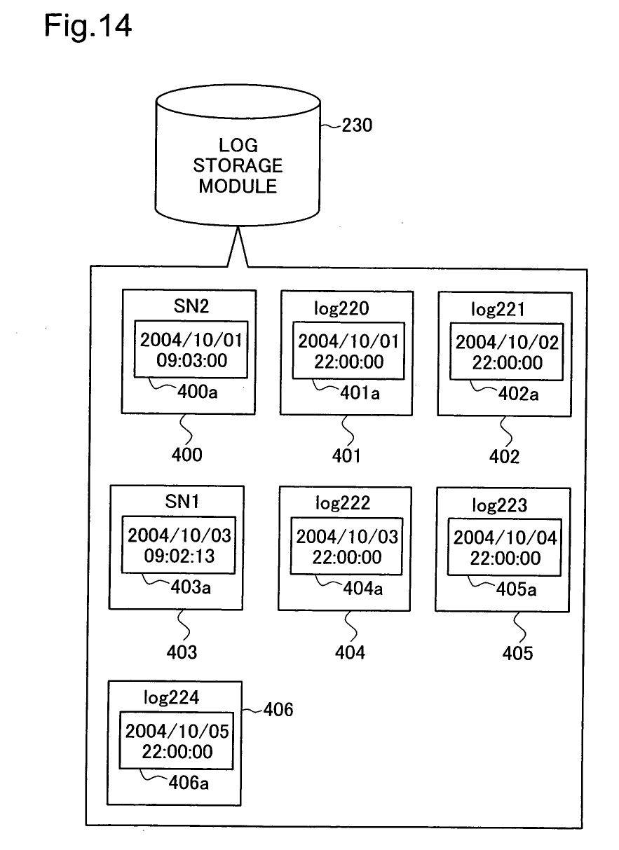

FIG. 14 illustrates the log storage module 230 of the network board NB1 in the second embodiment. As shown in FIG. 14, log files 400-406 are stored in the log storage module 230. Each log file 400-406 is assigned a log file collection time 400a-406a, respectively. The log files 400 and 403 have serial numbers. When the power supply of the printer PRT1 is turned ON, the network board NB1 stores a log file in which the current serial number 241 in the log storage module 230 when the serial number 241 and the serial number 241a are different.

B1-2. Management Server SV Function Block

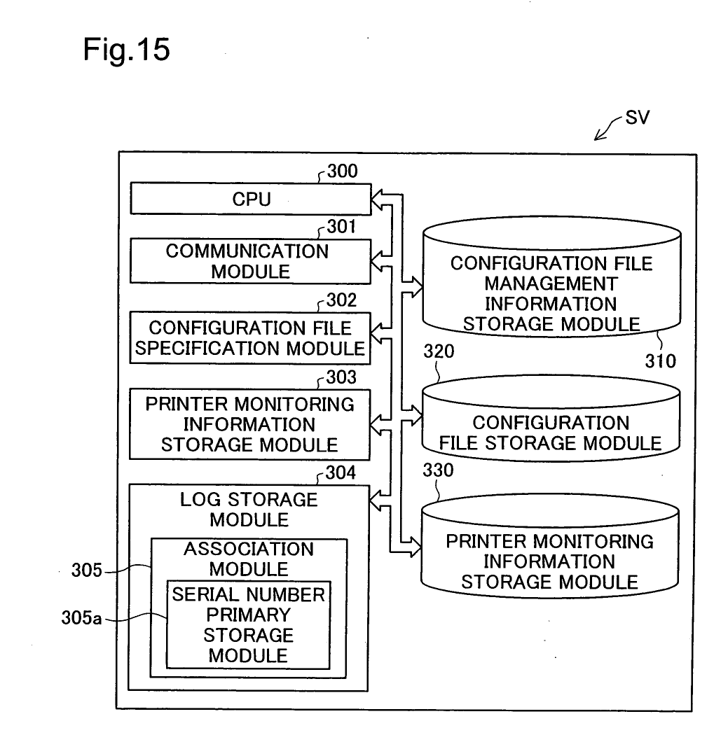

FIG. 15 illustrates function blocks of the management server SV in the second embodiment. Because the structure of the management server SV is identical to the structure of the management server SV of the first embodiment with the exception of the association module 305, description of the identical aspects of the construction will be omitted.

The association module 305 includes a serial number primary storage module 305a and comprises a part of the association module 305. The association module 305 refers to the log files that were uploaded from the network board NB1 in the order in which they were uploaded. When the log file contents comprise a serial number, association module 305 stores the serial number in the serial number primary storage module 305a. When the log file contents do not include a serial number, association module 305 associates with the serial numbers stored in the serial number primary storage module 305a and the log file name, and records the serial numbers and the log file name in the log management table 341. The log storage module 304 stores log files in the log DB 20.

B2. Log Connection Process

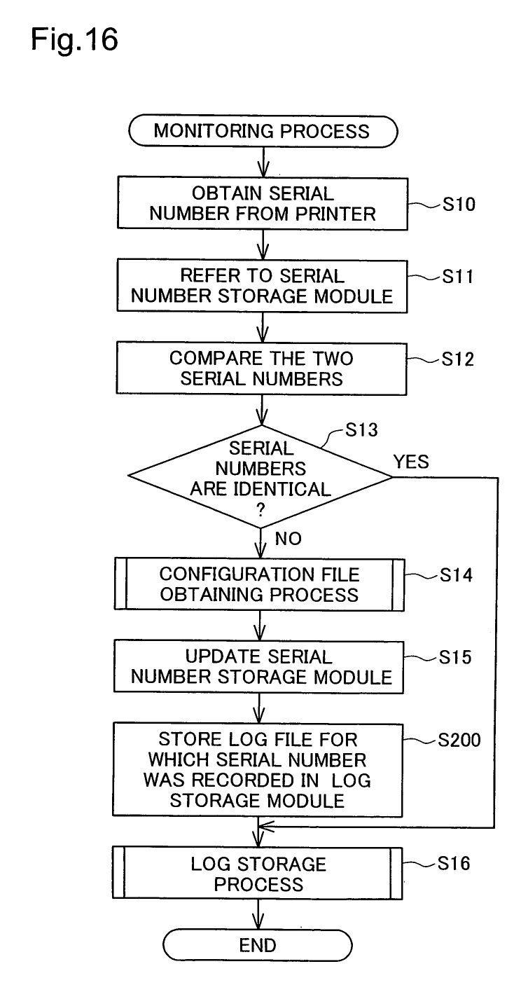

FIG. 16 is a flow chart showing the process by which the network board NB1 monitors the printer PRT1 in this embodiment. The network board NB1 begins this process when power supply of the printer PRT1 is turned ON. Steps of S10-S16 are identical to the corresponding steps in the first embodiment.

The network board NB1 obtains the current serial number 241 from the printing unit 250 (step S10). Next, the network board NB1 refers to the serial number storage module 240 and obtains the serial number 241a (step S11).

The network board NB1 then compares the current serial number 241 and the serial number 241a (step S12), determines whether or not the two serial numbers are identical (step S13). If the two serial numbers are identical (YES in step S13), the network board NB1 begins monitoring of the printer PRT1 and executes log collection processing (step S16).

If the two serial numbers are not identical (NO in step S13), the network board NB1 obtains the configuration file corresponding to the printer PRT1 (step S14) and updates the serial number storage module 240 (step S15).

The network board NB1 then generates a log file that records the current serial number 241 and stores this log file in the log storage module 230 (step S200), and thereafter begins the log collection process (step S16).

B3. Log Upload Process

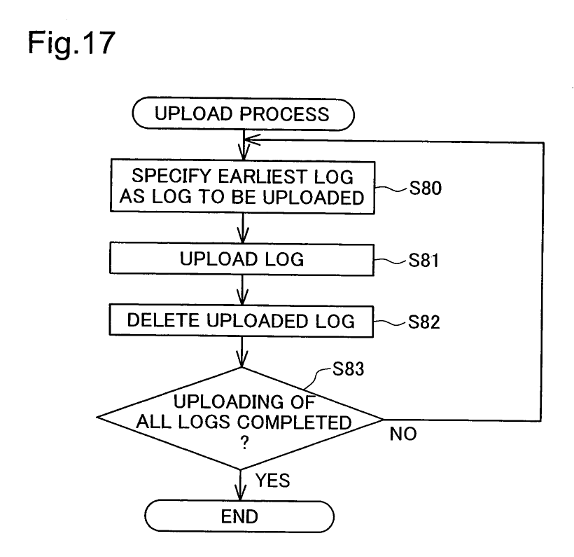

FIG. 17 illustrates the log file upload process in this embodiment.

The network board NB1 refers to the log storage module 230 and designates the log with the earliest collection time as the log to be uploaded (step S80). The network board NB1 then uploads the log to be uploaded to the management server SV (step S81) and deletes the uploaded log (step S82).

The network board NB1 determines whether uploading of all of the logs stored in the log storage module 230 has been completed (step S83), and if uploading of all logs has not been completed (NO in step S83), the log having the earliest collection time among the logs remaining in the log storage module 230 is designated as a log to be uploaded (step S80), and the process is repeated. When the network board NB1 completes uploading of all logs (YES in step S83), the network board NB1 ends processing.

B4. Log Storage Process

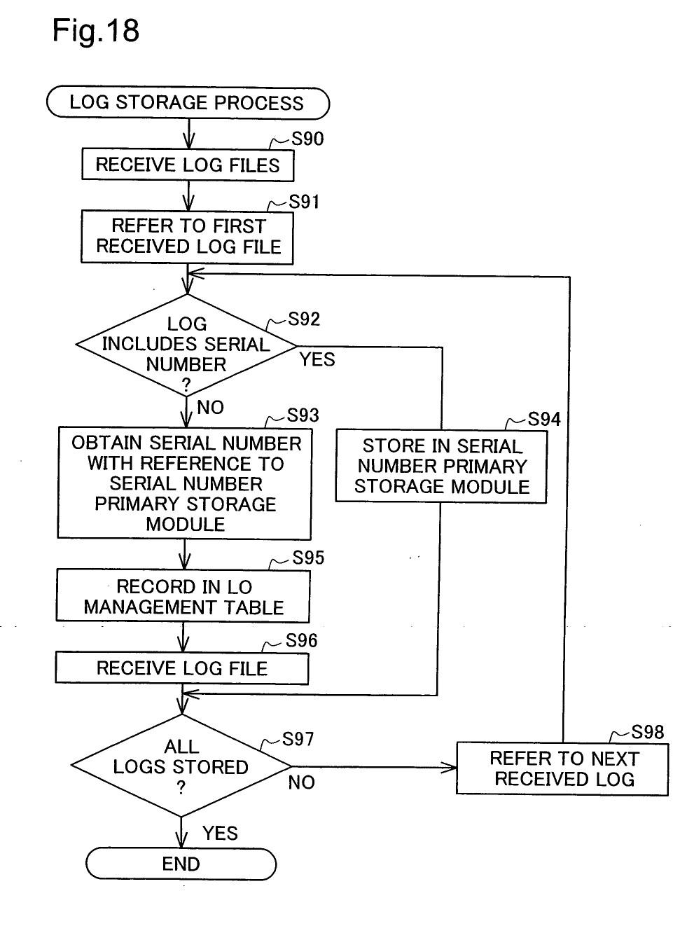

FIG. 18 is a flow chart showing the log storage process of this embodiment. The management server SV begins this process when log files uploaded from the network board NB1 are received.

When the management server SV receives log files uploaded from the network board NB1 (step S90), refers to the first received log file (step S91) and determines whether or not the log file contents comprise a serial number (step S92). If the log file contents includes a serial number (YES in step S92), the management server SV stores the serial number in the serial number primary storage module 305a (step S94) and determines whether or not all uploaded log files are stored in the log DB 20 (step S97). If the management server SV stores all log files (YES in step S97), processing ends. If the management server SV has not stored of all log files (NO in step S97), refers to the next received log file (step S98) and the operations beginning with step S92 are repeated.

If the log file contents do not comprise a serial number (NO in step S92), [the network board NB1] refers to the serial number primary storage module 305a, obtains the stored serial number (step S93), registers the association between the obtained serial number and the log file in the log management table 341 (step S95), and stores the log file in the log DB 20 (step S96). The network board NB1 then determines whether or not all uploaded log files are stored in the DB 20 (step S97). If all log files are stored (YES in step S97), processing is ended. If storage of all log files is not completed (NO in step S97), [the network board NB1 refers to the next received log file (step S98) and the operations beginning with step S92 are repeated.

According to the printer management system of the second embodiment described above, the network board NB1 generates log files in which a serial number is recorded such that the log files always have an earlier collection time than normal log files, and is able to upload a serial number log file and log files corresponding to that serial number. Because the management server SV is able to associate the log files received after a serial number log file is received and before the next serial number log file is received as the log files belonging to the previously received serial number log file, the log files uploaded from the network board NB1 is able to be easily associated with printers without the need to keep track of associations between the network board NB1 and printers.

In this embodiment, as shown in FIG. 17, the earliest log is designated as the log to be uploaded, and logs are deleted once uploading is completed, but the present invention is not limited to this implementation. For example, it is acceptable if the network board NB1 determines whether or not a transmitted log includes a serial number after log uploading (step S81), and if the transmitted log includes a serial number, the network board NB1 not delete the received serial number log immediately but deletes when the network board NB1 receives a different serial number, i.e., after all log files corresponding to the previously received serial number are received. As a result, even where some sort of problem occurs during uploading of a log file and log transmission is terminated, because the serial number log is not deleted, uploading that maintains log consistency is able to be carried out.

In this embodiment, a construction was described in which log files are uploaded only from the network board NB1, but the present invention is not limited to this implementation. Where log files are uploaded from multiple network boards, for example, the log storage process shown in FIG. 18 may be carried out for each network board MAC address.

C. Third Embodiment

In a third embodiment, the network board NB1 has printer monitoring information that specifies the time at which each printer was monitored by the network board NB1. The network board NB1 transmits printer monitoring information to the management server SV prior to log file uploading. The management server SV associates and stores log files and printers based on the received printer monitoring information.

C1. Function Blocks

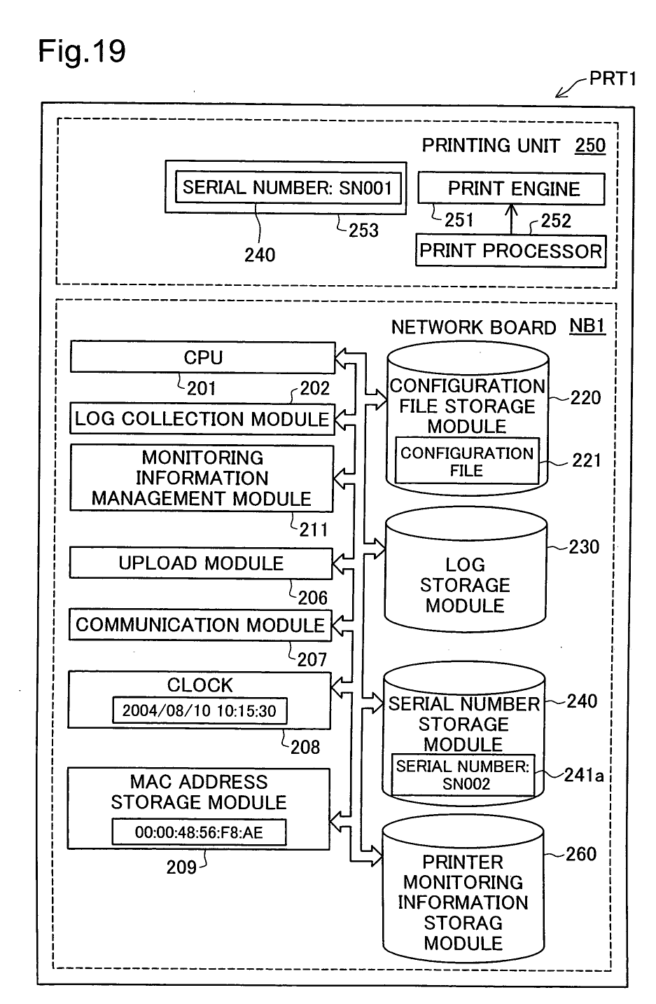

FIG. 19 illustrates the function blocks of the printer PRT1 of the third embodiment. Because these functions are identical to those of the first embodiment with the exceptions of the monitoring information management module 211, the printer monitoring information storage module 260 and the upload module 206, description of the identical functions will be omitted.

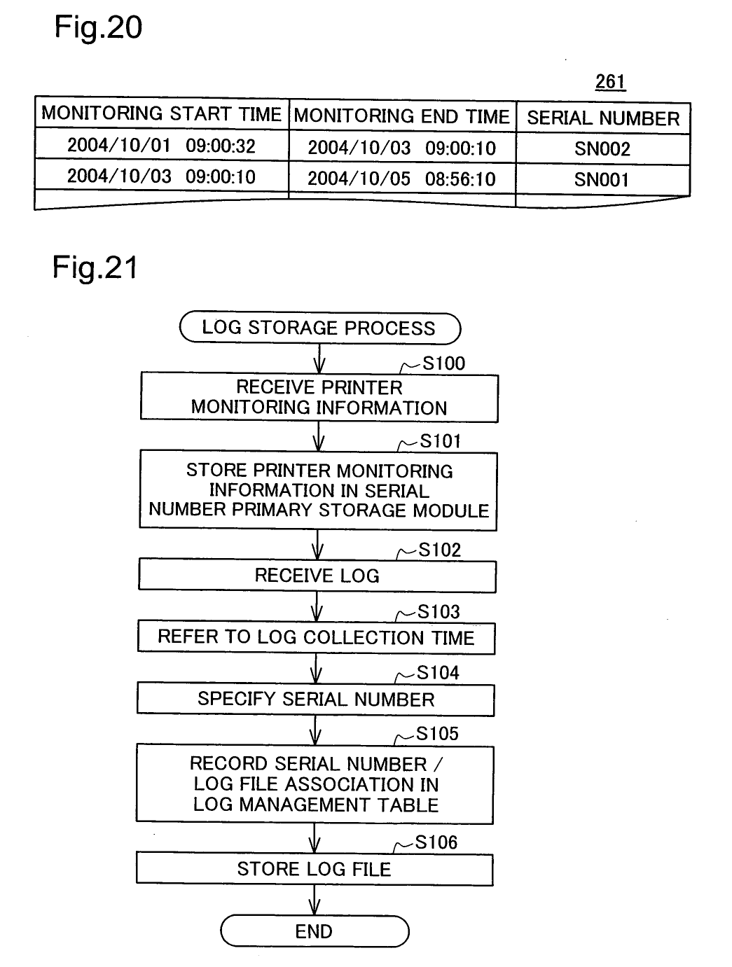

Printer monitoring information is stored in the printer monitoring information storage module 260. Information indicating the time at which the network board NB1 monitored each printer is registered in the printer monitoring information. The monitoring information management module 211 periodically refers to the clock 208 and registers in the printer monitoring information the time at which the network board NB1 is monitoring a printer, as well as the printer monitored. The contents of the printer monitoring information will be described with reference to FIG. 20.

FIG. 20 illustrates the printer monitoring information 261 in this embodiment. The printer monitoring information 261 has the three items of ‘Monitoring start time’, ‘Monitoring end time’ and ‘Serial number’. The printer monitoring information 261 indicates the periods during which a printer was monitored by the network board NB1 and the serial number of each monitored printer. For example, the printer monitoring information 261 indicates that the network board NB1 began monitoring of the printer having the serial number ‘SN002’ at ‘2004/10/01 09:00:32’ and ended monitoring at ‘2004/10/03 09:00:09’. In this embodiment, the network board NB1 detects that the network board NB1 has been replaced from the printer PRT2 to the printer PRT1, and because the printer PRT1 (serial number ‘SN001’) was monitored beginning at ‘2004/10/03 09:00:10’, the monitoring of the printer PRT2 is deemed to have ended just previously, i.e., at ‘2004/10/03 09:00:09’. It is alternatively acceptable if the time at which the power to the network board NB1 was turned OFF is stored immediately prior to the replacing of the network board NB, and this time is deemed the time at which monitoring ended.

Returning to FIG. 19, when the log file uploading time arrives, the upload module 206 obtains the printer monitoring information 261 with reference to the printer monitoring information storage module 260 and uploads the printer monitoring information 261 to the management server SV prior to log file uploading. After uploading of the printer monitoring information 261, log file uploading is carried out.

The construction of the management server SV is identical in the second and third embodiments, and the association module 305 includes a serial number primary storage module 305a.

C2. Log Storage Process

FIG. 21 is a flow chart showing the log storage process of this embodiment. When the printer monitoring information 261 uploaded from the network board NB1 is received (step S100), the management server SV stores the printer monitoring information 261 in the serial number primary storage module 305a (step S101).

Next, when an uploaded log file is received (step S102), the management server SV refers to the log file collection time (step S103) and specifies the serial number of the printer for which the log file was collected based on the printer monitoring information 261 stored in the printer monitoring information primary storage module 305a (step S104). The management server SV stores the specified serial number and log file name in the log management table (step S105) and stores the log file in the log DB 20 (step S106).

According to the printer management system of the third embodiment described above, the management server SV is able to associate a log file and a printer based on the received printer monitoring information 261. Therefore, the management server SV is able to reduce processing burden without needing to keep track of which printer is being monitored by the network board NB1.

Although the present invention has been described and illustrated in detail, it is clearly understood that the same is by way of illustration and example only and is not to be taken by way of limitation, the spirit and scope of the present invention being limited only by the terms of the appended claims. For example, in the above embodiments, the apparatuses to be managed by the management server SV were printers, but it may be other types of devices connected to a network, such as copying machines, projectors, or computer peripherals.

The Japanese patent applications as the basis of the priority claim of this application are incorporated in the disclosure here of by reference:

(1) Japanese Patent Application No. 2004-256638 (filing data: Sep. 3, 2004).

What is claimed is:

1. A device management apparatus that is connected with a device monitoring apparatus through a network, wherein the device monitoring apparatus monitors a device, the device management apparatus comprising:
a receiving module that receives use information and device identification information from the device monitoring apparatus, wherein the use information includes status of use of the device and the device identification information includes information for specifying the device that is targeted for monitoring;
a use information storage module that stores the received use information and the received device identification information;
an association module that associates the received use information and the received device identification information; and
a management module that manages the device based on the use information.

2. The device management apparatus according to claim 1, wherein
the device identification information includes information for specifying the period of time during which the device is targeted for monitoring;
the use information includes the obtained time of the use information; and
the association module associates the use information and the device identification information based on the device identification information and the obtained time.

3. The device management apparatus according to claim 2, further comprising
a device identification information storage module that stores the device identification information.

4. The device management apparatus according to claim 1, wherein
the device monitoring apparatus monitors multiple devices,
the association module associates the use information with a first device identification information for specifying a first device among the multiple devices, wherein the use information is received after receiving the first device identification information and prior to receiving second device identification information for specifying a second device.

5. The device management apparatus according to claim 1, wherein
the device identification information includes the serial number of the device.

6. The device management apparatus according to claim 2, wherein
the device identification information includes the serial number of the device.

7. The device management apparatus according to claim 3, wherein
the device identification information includes the serial number of the device.

8. The device management apparatus according to claim 4, wherein
the first device identification information includes the serial number of the first device; and
the second device identification information includes the serial number of the second device.

9. A device monitoring apparatus that is connected with a device management apparatus through a network, the device monitoring apparatus comprising:
a use information obtaining module that obtains use information including status of use of the device based on monitored item configuration information, wherein the monitored item configuration information has an item for monitoring the device;
a use information storage module that stores the obtained use information;
a device identification information obtaining module that obtains device identification information for specifying the device that is targeted for monitoring; and
a transmission module that transmits the use information and the device identification information to the device management apparatus.

10. The device monitoring apparatus according to claim 9, wherein
the device identification information includes device monitoring information for specifying the period of time during which the device is targeted for monitoring;
the device monitoring apparatus further comprises
a device identification information storage module that stores the device identification information; and
the transmission module transmits the device identification information to the device management apparatus prior to transmission of the use information.

11. The device monitoring apparatus according to claim 9, wherein
the transmission module transmits the device identification information to the device management apparatus when power supply of the device is turned ON, wherein the device identification information includes device monitoring information for specifying the period of time during which the device is targeted for monitoring.

12. The device monitoring apparatus according to claim 9, wherein
the device identification information obtaining module obtains the device identification information prior to obtaining of the use information;
the use information storage module stores the device identification information and the use information; and
the transmission module transmits the device identification information and the use information in ascending order of the obtained time.

13. The device monitoring apparatus according to claim 9, further comprising
a deletion module that deletes the use information and the device identification information after transmission by the transmission module is completed.

14. The device monitoring apparatus according to claim 10, further comprising
a deletion module that deletes the use information and the device identification information after transmission by the transmission module is completed.

15. The device monitoring apparatus according to claim 11, further comprising
a deletion module that deletes the use information and the device identification information after transmission by the transmission module is completed.

16. The device monitoring apparatus according to claim 12, further comprising
a deletion module that deletes the use information and the device identification information after transmission by the transmission module is completed.

17. A device management system that a device monitoring apparatus and a device management apparatus are connected through a network, that the device management system comprising:
the device monitoring apparatuses includes
a use information obtaining module that obtains use information including the status of use of a device based on monitored item configuration information, wherein the monitored item configuration information includes an item for monitoring a device;
a use information storage module that stores the obtained use information;
a device identification information obtaining module that obtains device identification information for specifying the device that is targeted for monitoring; and
a transmission module that transmits the use information and the device identification information to the device management apparatus,
the device management apparatus includes
a receiving module that receives the use information and the device identification information from the device monitoring apparatus;
a use information storage module that stores the received use information and the received device identification information;
an association module that associates the received use information and the received device identification information; and
a management module that manages the device based on the use information.

18. A device management method carried out by a device management apparatus connected with a device monitoring apparatus through a network, the device management method comprising:
receiving use information and device identification information from the device monitoring apparatus, wherein the use information includes status of use of a device and the device identification information includes information for specifying the device monitored by the device monitoring apparatus;
storing the received use information and the received device identification information;
associating the received use information and the received device identification information; and
managing the device based on the use information.

19. A device monitoring method carried out by a device monitoring apparatus connected with a device management apparatus through a network, the device monitoring method comprising:
obtaining use information including status of use of a device based on monitored item configuration information, wherein the monitored item configuration information has an item for monitoring the device;
storing the obtained use information;
obtaining device identification information for specifying the device that is targeted for monitoring; and
transmitting the use information and the device identification information to the device management apparatus.

20. A management method carried out by a device management system that has a device monitoring apparatus and a device management apparatus through a network, the management method comprising:
the device monitoring apparatus includes
obtaining use information including status of use of a device based on monitored item configuration information, wherein the monitored item configuration information includes an item for monitoring the device;
storing the obtained use information;
obtaining device identification information for specifying the device that is targeted for monitoring; and
transmitting the use information and the device identification information to the device management apparatus,
the device management apparatus includes
receiving-the use information and the device identification information from the device monitoring apparatus;
storing the received use information and the received device identification information;
associating the received use information and the received device identification information; and
managing the device based on the use information.
